(19) United States
(12) Patent Application Publication
(10) Pub. No.: US 2021/0286709 A1
(43) Pub. Date: Sep. 16, 2021

(54) SCREEN TEST APPARATUS AND COMPUTER READABLE MEDIUM

(71) Applicant: Mitsubishi Electric Corporation, Tokyo (JP)

(72) Inventors: Naotaka TANIYA, Tokyo (JP); Kouji MIYAZAKI, Tokyo (JP); Mariko UENO, Tokyo (JP); Hironobu ABE, Tokyo (JP)

(73) Assignee: Mitsubishi Electric Corporation, Tokyo (JP)

(21) Appl. No.: 16/606,491

(22) PCT Filed: May 15, 2017
(86) PCT No.: PCT/JP2017/018129

§ 371 Date: Oct. 18, 2019

(51) Int. Cl. G06F 11/36; G06F 3/0481; G06F 3/0484

(52) U.S. Cl. CPC G06F 11/3688; G06F 11/3692; G06F 3/0484; G06F 3/0481

(57) ABSTRACT

Definition data is data that defines a rule for determining that an object is displayed properly for each type of object to be displayed on a screen of an application. Image data is data that records a screen of the application during execution of the application. An anomaly detection unit of a screen test apparatus extracts at least one type of object from the image data. The anomaly detection unit refers to the definition data to determine whether a rule corresponding to a type of an extracted object is followed, so as to detect an anomaly in the screen of the application recorded in the image data.

### TECHNICAL FIELD

The present invention relates to a screen test apparatus and a screen test program.

### BACKGROUND ART

In the technology described in Patent Literature 1, a test item table that indicates positions and so on of display items of a GUI control program is created from a screen design specification, and a screen item table that is in the same format as the test item table is created from a screen analysis result. The test item table and the screen item table are compared, so as to determine whether the position or the like of each item is correct. “GUI” is an abbreviation for Graphical User Interface.

### CITATION LIST

### Patent Literature

Patent Literature 1: JP 11-175370 A

### SUMMARY OF INVENTION

### Technical Problem

In the related art, those at the same coordinates are compared in screen tests, so that test results cannot be evaluated correctly when tests are performed on terminals that differ in screen size or screen resolution, or tests are performed on web browsers that differ in type. Creating a test item table for each terminal or each type of web browser may be considered, but test efficiency will greatly decrease in such a case.

It is an object of the present invention to improve efficiency of a screen test.

### Solution to Problem

A screen test apparatus according to one aspect of the present invention includes:

a definition acquisition unit to acquire, from a memory, definition data that defines, for each type of object to be displayed on a screen of an application, a rule for determining that an object is displayed properly;

an image acquisition unit to acquire, from the memory, image data that records a screen of the application during execution of the application; and

an anomaly detection unit to extract at least one type of object from the image data acquired by the image acquisition unit, and refer to the definition data acquired by the definition acquisition unit to determine whether a rule corresponding to a type of an extracted object is followed, so as to detect an anomaly in the screen of the application recorded in the image data.

The image acquisition unit acquires, as the image data, data that records a screen of the application of each terminal when the application is executed on terminals that differ in at least one of screen size and screen resolution, and the anomaly detection unit detects an anomaly in the screen of the application of each terminal recorded in the image data.

The image acquisition unit acquires, as the image data, data that records a screen of each type of the application during execution of different types of the application, and

the anomaly detection unit detects an anomaly in the screen of each type of the application recorded in the image data.

The screen test apparatus further includes

a source acquisition unit to acquire, from the memory, a source file that corresponds to the screen of the application recorded in the image data, and that includes at least one of a file written in a markup language and a file written in a style sheet language, and

the anomaly detection unit refers to the source file acquired by the source acquisition unit to compute a position where the at least one type of object is displayed on the screen of the application, and extracts the at least one type of object from the computed position in the image data.

The anomaly detection unit extracts the at least one type of object from the image data by performing image recognition.

The definition acquisition unit acquires, as the definition data, data that defines a corresponding rule and records a template image of a modeled object for at least one type of object, and

when a template image corresponding to the type of the extracted object is recorded in the definition data, the anomaly detection unit determines whether a rule corresponding to the type of the extracted object is followed by performing template matching using the template image concerned.

When the anomaly detection unit has determined that the rule corresponding to the type of the extracted object is not followed, the anomaly detection unit outputs a determination result, and accepts from a user an input of a judgment result as to whether the determination result that has been output is correct.

When a judgment result indicating that the determination result that has been output is incorrect is input from the user, the anomaly detection unit accepts a modification of a rule defined in the definition data from the user, and causes the modification to be reflected in the definition data.

A screen test program according to one aspect of the present invention causes a computer to execute:

a definition acquisition process to acquire, from a memory, definition data that defines, for each type of object to be displayed on a screen of an application, a rule for determining that an object is displayed properly; an image acquisition process to acquire, from the memory, image data that records a screen of the application during execution of the application; and an anomaly detection process to extract at least one type of object from the image data acquired by the image acquisition process, and refer to the definition data acquired by the definition acquisition process to determine whether a rule corresponding to a type of an extracted object is followed, so as to detect an anomaly in the screen of the application recorded in the image data. Advantageous Effects of Invention

According to the present invention, a screen test can be performed without pre-defining positions and so on of individual objects, so that efficiency of the screen test improves.

### BRIEF DESCRIPTION OF DRAWINGS

FIG. 1 is a block diagram illustrating a configuration of a screen test apparatus according to a first embodiment;

FIG. 2 is a table illustrating an example of definition data of the screen test apparatus according to the first embodiment;

FIG. 3 is a diagram illustrating an example of image data of the screen test apparatus according to the first embodiment;

FIG. 4 is a diagram illustrating an example of a source file of the screen test apparatus according to the first embodiment;

FIG. 5 is a diagram illustrating an example of a source file of the screen test apparatus according to the first embodiment;

FIG. 6 is a flowchart illustrating operation of the screen test apparatus according to the first embodiment; and

FIG. 7 is a flowchart illustrating operation of an anomaly detection unit of the screen test apparatus according to the first embodiment.

### DESCRIPTION OF EMBODIMENTS

An embodiment of the present invention will be described hereinafter with reference to the drawings. Throughout the drawings, the same or corresponding parts are denoted by the same reference signs. In the description of the embodiment, description of the same or corresponding parts will be omitted or simplified as appropriate. Note that the present invention is not limited to the embodiment to be described hereinafter, and various modifications are possible as necessary. For example, the embodiment to be described hereinafter may be partially implemented.

### First Embodiment

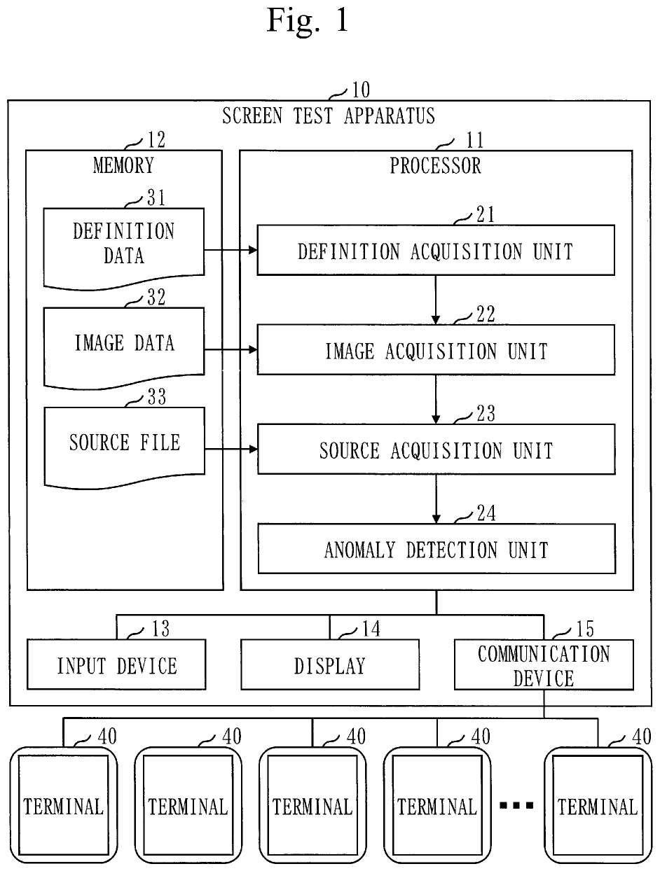

This embodiment will be described with reference to FIGS. 1 to 7.

Description of Configuration

A configuration of a screen test apparatus 10 according to this embodiment will be described with reference to FIG. 1.

The screen test apparatus 10 is a computer. The screen test apparatus 10 includes a processor 11, and also includes other hardware such as a memory 12, an input device 13, a display 14, and a communication device 15. The processor 11 is connected with the other hardware via signal lines and controls the other hardware.

The screen test apparatus 10 includes, as functional elements, a definition acquisition unit 21, an image acquisition unit 22, a source acquisition unit 23, and an anomaly detection unit 24. The functions of the definition acquisition unit 21, the image acquisition unit 22, the source acquisition unit 23, and the anomaly detection unit 24 are realized by software.

The processor 11 is a device that executes a screen test program. The screen test program is a program that realizes the functions of the definition acquisition unit 21, the image acquisition unit 22, the source acquisition unit 23, and the anomaly detection unit 24. The processor 11 is, for example, a CPU. “CPU” is an abbreviation for Central Processing Unit.

The memory 12 is a device that stores the screen test program. The memory 12 is, for example, a flash memory or a RAM. “RAM” is an abbreviation for “Random Access Memory”.

The input device 13 is a device that is operated by a user to input data to the screen test program. The input device 13 is, for example, a mouse, a keyboard, or a touch panel.

The display 14 is a device that displays data output from the screen test program on a screen. The display 14 is, for example, an LCD. “LCD” is an abbreviation for Liquid Crystal Display.

The communication device 15 includes a receiver that receives data input to the screen test program and a transmitter that transmits data output from the screen test program. The communication device 15 is, for example, a communication chip or a NIC. “NIC” is an abbreviation for Network Interface Card.

The screen test program is read into the processor 11 and executed by the processor 11. The memory 12 stores not only the screen test program but also an OS. “OS” is an abbreviation for Operating System. The processor 11 executes the screen test program while executing the OS.

The screen test program and the OS may be stored in an auxiliary storage device. The auxiliary storage device is, for example, a flash memory or an HDD. “HDD” is an abbreviation for Hard Disk Drive. The screen test program and the OS that are stored in the auxiliary storage device are loaded into the memory 12 and executed by the processor 11.

Note that part or the entirety of the screen test program may be embedded in the OS.

The screen test apparatus 10 may include a plurality of processors in place of the processor 11. The plurality of processors share execution of the screen test program. Like the processor 11, each of the plurality of processors is a device that executes the screen test program.

Data, information, signal values, and variable values that are used, processed, or output by the screen test program are stored in the memory 12, the auxiliary storage device, or a register or a cache memory in the processor 11.

The screen test program is a program that causes a computer to execute processes, where “unit” of each of the definition acquisition unit 21, the image acquisition unit 22, the source acquisition unit 23, and the anomaly detection unit 24 is interpreted as “process”, or causes a computer to execute steps, where “unit” of each of the definition acquisition unit 21, the image acquisition unit 22, the source acquisition unit 23, and the anomaly detection unit 24 is interpreted as “step”. The screen test program may be provided by being recorded on a computer readable medium or may be provided as a program product.

The memory 12 stores definition data 31.

The definition data 31 is data that defines a rule for determining that an object is displayed properly for each type of object to be displayed on an application screen. An application is, for example, a web browser. In this embodiment, the definition data 31 is data that defines a corresponding rule and records a template image of a modeled object for at least one type of object. The definition data 31 may be data in any format. In this embodiment, the definition data 31 is in a database table format.

The definition data 31 is input via the input device 13 by a user who tests the screen. Alternatively, the definition data 31 is acquired via the communication device 15 from a server, a storage, or the like external to the screen test apparatus 10.

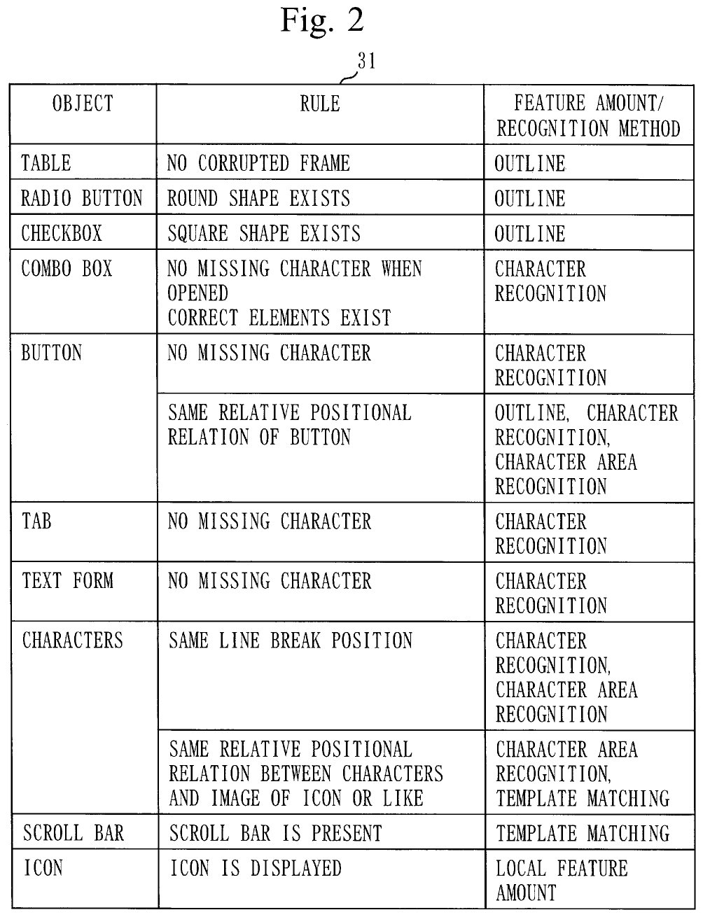

The definition data 31 illustrated in FIG. 2 defines a rule for determining that an object is displayed properly, and also defines a model to be a basis for determining that the rule is followed or a recognition method used for determining that the rule is followed, for each of ten types of objects as described below.
(1) For a table, a rule of “no corrupted frame” is defined, and a feature amount of “outline” is defined as a model.
(2) For a radio button, a rule of “round shape exists” is defined, and a feature amount of “outline” is defined as a model.
(3) For a checkbox, a rule of “square shape exists” is defined, and a feature amount of “outline” is defined as a model.
(4) For a combo box, two rules of “no missing character when opened” and “correct elements exist” are defined, and use of “character recognition” is defined as a recognition method.
(5) For a button, a rule of “no missing character” is defined, and use of “character recognition” is defined as a recognition method. In addition, a rule of “same relative positional relation of button” is defined, a feature amount of “outline” is defined as a model, and use of “character recognition” and use of “character area extraction” are defined as recognition methods.
(6) For a tab, a rule of “no missing character” is defined, and use of “character recognition” is defined as a recognition method.
(7) For a text form, a rule of “no missing character” is defined, and use of “character recognition” is defined as a recognition method.
(8) For characters, a rule of “same line break position” is defined, and use of “character recognition” and use of “character area extraction” are defined as recognition methods.

In addition, a rule of “same relative positional relation between characters and image of icon or like” is defined, and use of “character area extraction” and use of “template matching” are defined as recognition methods. Although not illustrated in the drawing, a template image used for “template matching” is also recorded. (9) For a scroll bar, a rule of “scroll bar is present” is defined, and use of “template matching” is defined as a recognition method. Although not illustrated in the drawing, a template image used for “template matching” is also recorded. (10) For an icon, a rule of “icon is displayed” is defined, and “local feature amount” is defined as a model.

The memory 12 further stores image data 32.

The image data 32 is data that records the application screen during execution of the application. That is, the image data 32 is a screenshot of the application screen. In this embodiment, the image data 32 is data that records the entire application screen as one image. However, the image data 32 may be data that records the application screen as separate images of individual areas each including an object.

The image data 32 is acquired via the communication device 15 from a terminal 40 executing the application. Alternatively, the image data 32 is generated by simulating within the screen test apparatus 10 the operation of the terminal 40 executing the application. Regardless of whether being acquired from the terminal 40 or being generated within the screen test apparatus 10, the image data 32 can be generated efficiently by taking a screenshot while automatically operating the application using a commonly used automation tool.

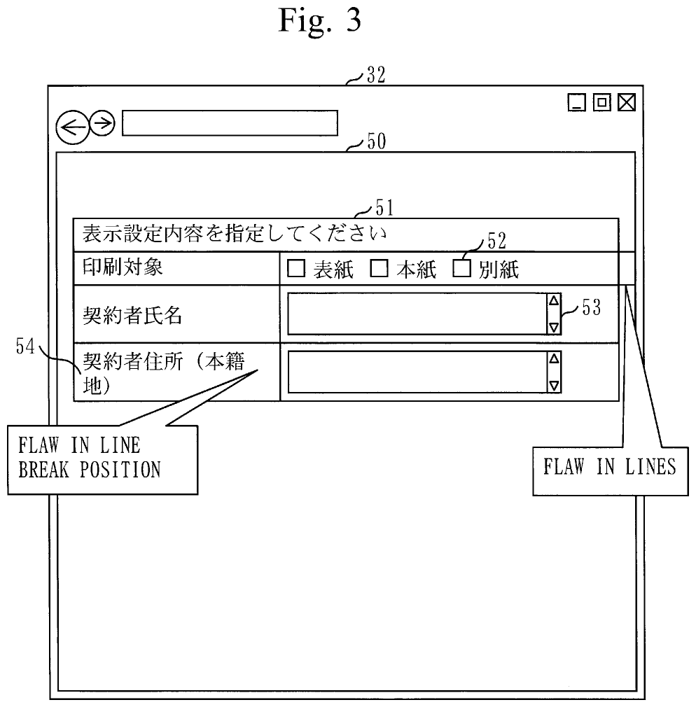

In the image data 32 illustrated in FIG. 3, a request screen 50 displayed in the Japanese language is recorded as a web browser screen. At least four types of objects are displayed on the request screen 50, as described below.
(1) A table 51 is displayed, but there is a flaw in lines.
(2) Three checkboxes 52 are displayed properly.
(3) Two text forms 53 are displayed properly.
(4) Characters 54 such as [symbol] [symbol] [symbol] [symbol] and [symbol] are displayed, but there is a flaw in the break line position in

[symbol]

The memory 12 further stores a source file 33.

The source file 33 is a file corresponding to the application screen recorded in the image data 32. The source file 33 includes at least one of a file written in a markup language and a file written in a style sheet language. A file written in a markup language is, for example, an HTML file. “HTML” is an abbreviation for HyperText

Markup Language. A file written in a style sheet language is, for example, a CSS file. “CSS” is an abbreviation for Cascading Style Sheets.

The source file 33 is acquired together with the image data 32 via the communication device 15 from the terminal 40 executing the application. Alternatively, the source file 33 is acquired via the communication device 15 from a server, a storage, or the like external to the screen test apparatus 10, and is used within the screen test apparatus 10 for simulation of the operation of the terminal 40 executing the application.

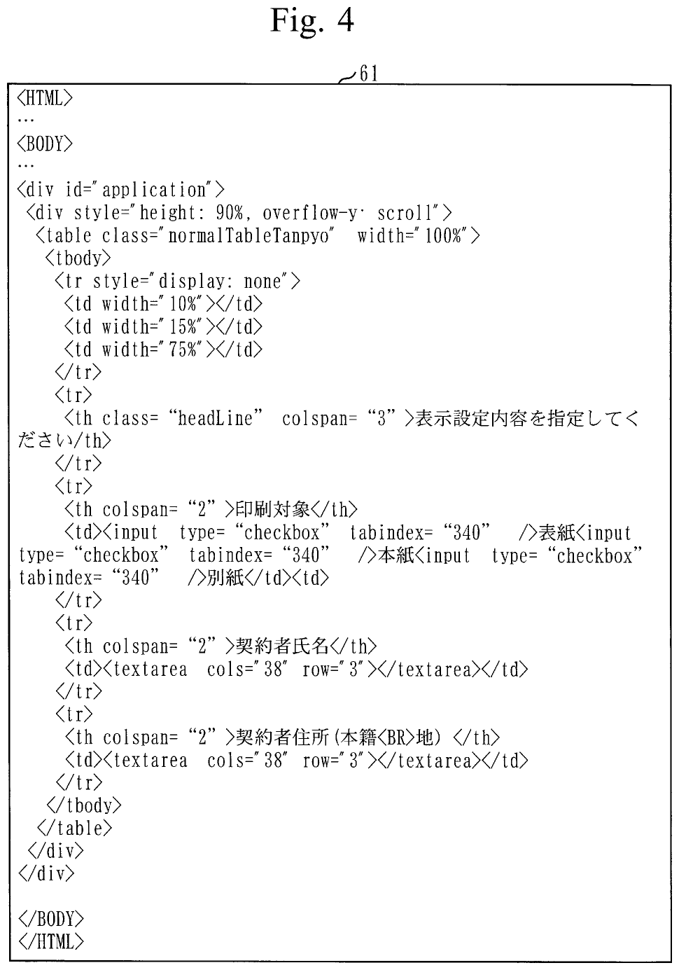

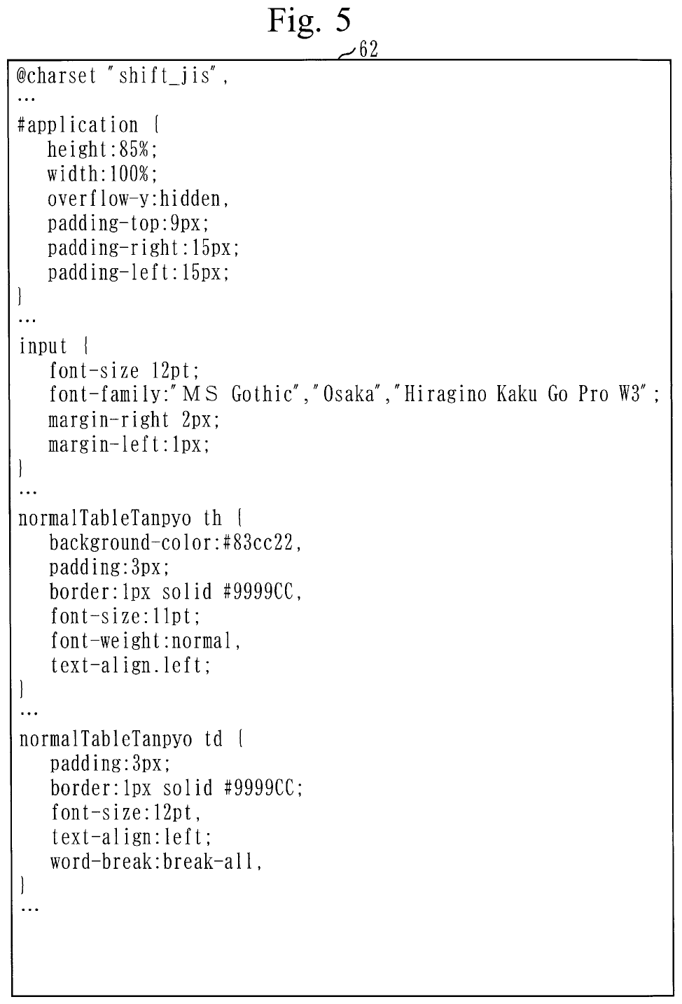

The source files 33 illustrated in FIGS. 4 and 5 are an HTML file 61 and a CSS file 62, respectively, and both correspond to the request screen 50 recorded in the image data 32 illustrated in FIG. 3.

Description of Operation

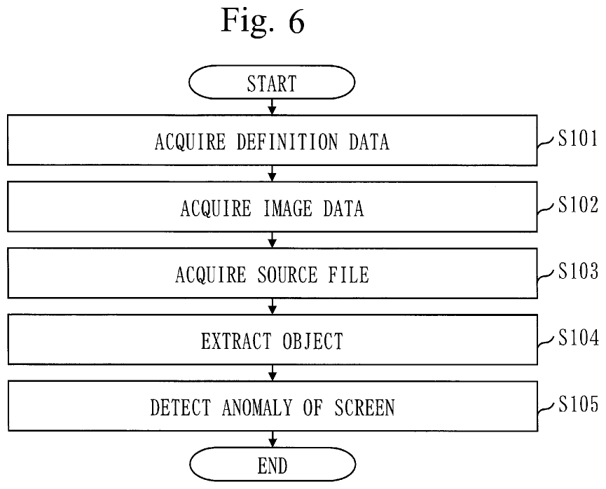

Operation of the screen test apparatus 10 according to this embodiment will be described with reference to FIG. 6. The operation of the screen test apparatus 10 is equivalent to a screen test method according to this embodiment.

In step S101, the definition acquisition unit 21 acquires definition data 31 from the memory 12.

In step S102, the image acquisition unit 22 acquires image data 32 from the memory 12.

In step S103, the source acquisition unit 23 acquires a source file 33 from the memory 12.

Note that the order of the processes of step S101 to step S103 can be changed as appropriate. The processes of step S101 to step S103 may be performed in parallel.

In step S104, the anomaly detection unit 24 extracts at least one type of object from the image data 32 acquired by the image acquisition unit 22.

Specifically, the anomaly detection unit 24 refers to the source file 33 acquired by the source acquisition unit 23 to compute a position where at least one type of object is displayed on the application screen. The anomaly detection unit 24 extracts the at least one type of object concerned by acquiring an image of the at least one type of object concerned from the calculated position in the image data 32 acquired by the image acquisition unit 22. The anomaly detection unit 24 here stores the acquired image in the memory 12.

For example, the anomaly detection unit 24 refers to the HTML file 61 illustrated in FIG. 4 and the CSS file 62 illustrated in FIG. 5 to compute a position where the table 51 is displayed on the request screen 50 of FIG. 3. As a method for computing the position, any method may be used. It is assumed here that the X coordinate and Y coordinate of the upper left corner of the table 51 and the width and height of the table 51 are calculated using a conventional method, and a rectangular area that is determined based on the calculation results is treated as a position computation result. The anomaly detection unit 24 acquires an image of the table 51 by cutting out the calculated rectangular area from the image data 32 illustrated in FIG. 3.

For example, the anomaly detection unit 24 refers to the HTML file 61 illustrated in FIG. 4 and the CSS file 62 illustrated in FIG. 5 to compute a position where each checkbox 52 is displayed on the request screen 50 of FIG. 3. As a method for computing the position, any method may be used. It is assumed here that the X coordinate and Y coordinate of the upper left corner of each checkbox 52 and the width and height of each checkbox 52 are calculated using a conventional method, and a rectangular area that is determined based on the calculation results is treated as a position computation result. The anomaly detection unit 24 acquires an image of each checkbox 52 by cutting out the calculated rectangular area from the image data 32 illustrated in FIG. 3.

For example, the anomaly detection unit 24 refers to the HTML file 61 illustrated in FIG. 4 and the CSS file 62 illustrated in FIG. 5 to compute a position where the characters 54 of [symbol] are displayed on the request screen 50 of FIG. 3. As a method for computing the position, any method may be used. It is assumed here that the X coordinate and Y coordinate of the upper left corner of the characters 54 of [symbol] and the width and height of the characters 54 of [symbol] are calculated using a conventional method, and a rectangular area that is determined based on the calculation results is treated as a position computation result. The anomaly detection unit 24 acquires an image of the characters 54 of [symbol] by cutting out the calculated rectangular area from the image data 32 illustrated in FIG. 3.

Note that instead of referring to the source file 33 or in addition to referring to the source file 33, the anomaly detection unit 24 may refer to a document such as a design specification of the application screen to compute a position where at least one type of object is displayed on the application screen. Also in that case, the anomaly detection unit 24 extracts the at least one type of object concerned by acquiring an image of the at least one type of object concerned from the calculated position in the image data 32 acquired by the image acquisition unit 22.

Alternatively, the anomaly detection unit 24 may perform image recognition to extract at least one type of object from the image data 32. In that case, an object may be directly extracted by image recognition, but it may be difficult to extract an object that is not displayed properly. For this reason, it is desirable to extract an object by first extracting an element that marks the presence of the object by image recognition and then cutting out an area in the vicinity of the element.

As a specific variation, it is assumed that element data is stored in the memory 12. The element data defines, for each type of object to be displayed on the application screen, at least one of elements which are characters and graphics displayed adjacent to or in the vicinity of an object. The anomaly detection unit 24 performs image recognition to extract one or more elements from the image data 32. The anomaly detection unit 24 refers to the element data stored in the memory 12 to extract an object from a side of or inside the extracted element or elements in the image data 32. For example, from the image data 32 illustrated in FIG. 3, it is possible to extract the characters 54 such as [symbol] and [symbol] as elements, and then extract the text form 53 from the right side of these elements.

In step S105, the anomaly detection unit 24 refers to the definition data 31 acquired by the definition acquisition unit 21 to determine whether the rule corresponding to the type of an object extracted in step S103 is followed, so as to detect an anomaly in the application screen recorded in the image data 32 acquired by the image acquisition unit 22.

The process of step S105 allows the anomaly detection unit 24 to use the common definition data 31 to check whether an anomaly occurs in the application screen, regardless of the screen resolution, screen size, and OS of the terminal 40 executing the application and regardless of the type of the application.

For example, it is assumed that in step S102 the image acquisition unit 22 acquires, as the image data 32, data that records the application screen of each terminal 40 when the application is executed on terminals 40 that differ in at least one of screen size and screen resolution. In that case, in step S105, the anomaly detection unit 24 can refer to the common definition data 31 to detect an anomaly in the application screen of each terminal 40 recorded in the image data 32.

Therefore, the anomaly detection unit 24 can use common definition data 31 to identify a terminal 40 in which an anomaly occurs when web screens having a common source file 33 are displayed on terminals 40 that differ in type, such as a PC, a tablet, and a smartphone. Alternatively, the anomaly detection unit 24 can use common definition data 31 to identify a terminal 40 in which an anomaly occurs when web screens having a common source file 33 are displayed on terminals 40 that differ in OS. “PC” is an abbreviation for Personal Computer.

For example, it is assumed that in step S102 the image acquisition unit 22 acquires, as the image data 32, data that records the application screen of each type of application during execution of different types of applications. In that case, in step S105, the anomaly detection unit 24 can refer to the common definition data 31 to detect an anomaly in the application screen of each type of application recorded in the image data 32.

Therefore, the anomaly detection unit 24 can use common definition data 31 to identify a web browser in which an anomaly occurs when web screens having a common source file 33 are displayed on web browsers that differ in type. Alternatively, the anomaly detection unit 24 can use common definition data 31 to identify a web browser in which an anomaly occurs when web screens having a common source file 33 are displayed on web browsers that differ in version.

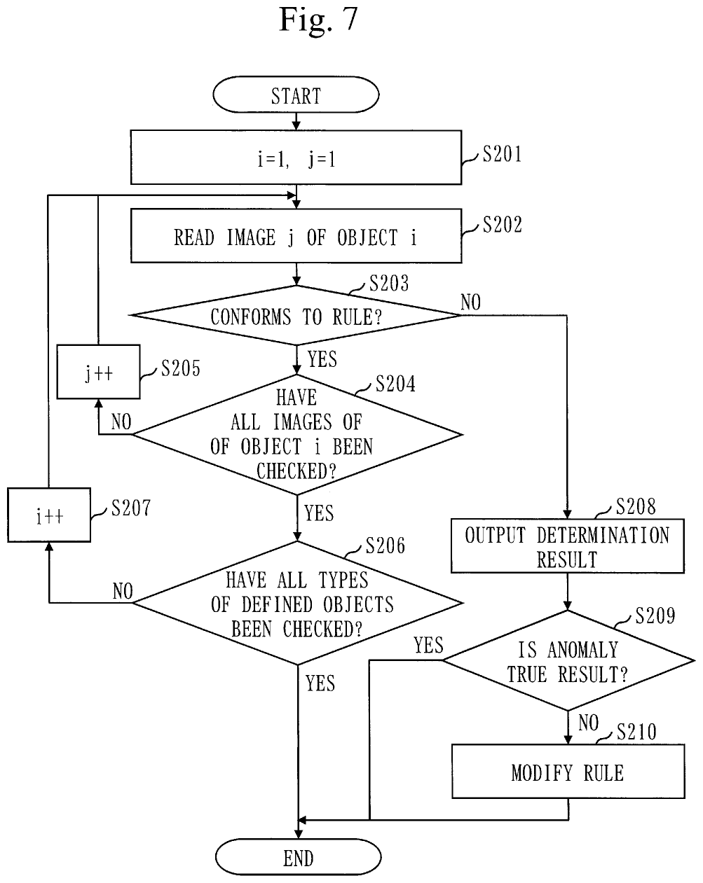

The process of step S105 will be described in detail with reference to FIG. 7.

In step S201, the anomaly detection unit 24 initializes to “1” each of a counter i corresponding to a type of object and a counter j corresponding to an image of an object i.

In step S202, the anomaly detection unit 24 reads an image j of the object i stored in the memory 12 in step S104.

In step S203, the anomaly detection unit 24 refers to the definition data 31 acquired in step S101 to determine whether the image j of the object i read in step S202 conforms to the rule corresponding to the object i. At this time, if a template image corresponding to the object i is recorded in the definition data 31, the anomaly detection unit 24 determines whether the image j of the object i conforms to the rule by performing template matching using the template image concerned. If the image j of the object i conforms to the rule, the process of step S204 is performed. If the image j of the object i does not conform to the rule, the process of step S208 is performed.

For example, the anomaly detection unit 24 refers to the definition data 31 illustrated in FIG. 2 to calculate the feature amount of “outline” of an image of the table 51 acquired from the image data 32 illustrated in FIG. 3, and compares the calculation result with the table model. Based on the comparison result, the anomaly detection unit 24 determines whether the image of the table 51 conforms to the rule of “no corrupted frame”. In the image data 32 illustrated in FIG. 3, there is a flaw in lines, so that it is determined that the image of the table 51 does not conform to the rule.

For example, the anomaly detection unit 24 refers to the definition data 31 illustrated in FIG. 2 to calculate the feature amount of “outline” of an image of each checkbox 52 acquired from the image data 32 illustrated in FIG. 3, and compares the calculation result with the checkbox model. Based on the comparison result, the anomaly detection unit 24 determines whether the image of each checkbox 52 conforms to the rule of “square shape exists”. In the image data 32 illustrated in FIG. 3, each checkbox 52 is displayed properly, so that it is determined that the image of each checkbox 52 conforms to the rule.

For example, the anomaly detection unit 24 refers to the definition data 31 illustrated in FIG. 2 to execute “character recognition” and “character area extraction” on an image of the characters 54 of [symbol] acquired from the image data 32 illustrated in FIG. 3. Based on the execution result, the anomaly detection unit 24 determines whether the image of the characters 54 of [symbol] conforms to the rule of “same line break position”. In the image data 32 illustrated in FIG. 3, there is a flaw in the line break position in [symbol] and this is assumed to be regarded as not “same line break position”. Then, it is determined that the image of the characters 54 of [symbol] does not conform to the rule.

Note that the anomaly detection unit 24 may determine whether the image of the characters 54 conforms to the rule of “same line break position” by calculating the number of characters in [symbol] based on the HTML file 61 illustrated in FIG. 4, and comparing the width of the characters 54 calculated in step S104 with a numerical value obtained by multiplying the calculated number of characters by a threshold value of the width of one character. Assume that no line break is to be regarded as “same line break position”, the threshold value of the width of one character is 20 pixels, and a DOM width calculated in step S104 is 160 pixels. Then, since the number of characters in [symbol] is 10 characters, the DOM width is less than required 200 pixels. Therefore, it is determined that the image of the characters 54 of [symbol] does not conform to the rule. “DOM” is an abbreviation for Document Object Model.

In step S204, the anomaly detection unit 24 determines whether all images of the object i have been checked. If all images of the object i have been checked, the process of step S205 is performed. If all images of the object i have not been checked, the process of step S206 is performed.

In step S205, the anomaly detection unit 24 increments the counter j by “1”. Then, the process of step S202 is performed again.

In step S206, the anomaly detection unit 24 determines whether all types of objects defined in the definition data 31 have been checked. If all types of objects have not been checked, the process of step S207 is performed. If all types of objects have been checked, the process of step S105 ends.

In step S207, the anomaly detection unit 24 increments the counter i by “1”.

Then, the process of step S202 is performed again.

In step S208, the anomaly detection unit 24 outputs the determination result of step S203 to the display 14. That is, if the anomaly detection unit 24 has determined that the rule corresponding to the type of an object extracted in step S103 is not followed, the anomaly detection unit 24 outputs this determination result. As the determination result, a message is output that notifies the user of an anomaly in the screen recorded in the image data 32 acquired in step S102. Note that a message or an image may be output that notifies of a portion of the screen not displayed properly.

In step S209, the anomaly detection unit 24 causes the user to judge whether the determination result output in step S208 is correct, and accepts an input of the judgment result from the user via the input device 13. That is, the anomaly detection unit 24 accepts, from the user, an input of the judgment result as to whether the determination result output in step S208 is correct. If the determination result is correct, the process of step S105 ends. If the determination result is not correct, the process of step S210 is performed.

In step S210, the anomaly detection unit 24 accepts a modification, such as broadening, of a rule defined in the definition data 31 stored in the memory 12 from the user via the input device 13. The anomaly detection unit 24 updates the definition data 31 stored in the memory 12 to data that defines the modified rule. That is, if the judgment result indicating that the determination result output by the anomaly detection unit 24 is incorrect is input from the user in step S209, the anomaly detection unit 24 accepts a modification of a rule defined in the definition data 31 stored in the memory 12 from the user, and causes the modification to be reflected in the definition data 31 stored in the memory 12. As a modification of a rule in step S210, for example, it is possible to add or delete a character recognition rule, or change a threshold value of template matching. After the process of step S210 is performed, the process of S105 ends. Note that after the process of step S210 is performed, the process of step S204 or step S206 may be consecutively performed.

The processes of step S209 and step S210 allow the user to visually judge whether an object that has been determined to be anomalous is actually anomalous, and provide feedback on the definition data 31.

Note that even when detecting an image that does not conform to the rule in step S203, the anomaly detection unit 24 may perform the process of step S204 and the subsequent steps, instead of immediately performing the processes of step S208 and the subsequent steps. Then, after all images of the object i have been checked or all types of objects have been checked, the anomaly detection unit 24 may perform the processes of step S208 and the subsequent steps collectively. Alternatively, even when detecting an image that does not conform to the rule in step S203, the anomaly detection unit 24 may perform only the process of step S208 and then proceed to perform the processes of step S204 and the subsequent steps. Then, after all images of the object i have been checked, or all types of objects have been checked, the anomaly detection unit 24 may perform the processes of step S209 and the subsequent step collectively. By performing the processes of step S209 and the subsequent step collectively on a plurality of images determined not to be in conformity with the rules, the judgment and modification work of the user in step S209 and step S210 can be done efficiently.

In this embodiment, the process of step S105 is started after the process of step S104 has been completed for all types of objects. As a variation, however, the processes of step S104 and step S105 may be performed for each type of object. That is, the process of step S104 and the process of step S105, which is described with reference to FIG. 7, can be executed consecutively for each type of object. In that case, for each object defined in the definition data 31, objects included in the image data 32 are extracted in step S104, and anomaly determination is performed on the objects in step S105. Specifically, table objects are extracted in step S104, and all the extracted tables are checked against the rule for tables in step S105. Extraction of objects and checking against the rules are performed sequentially for radio buttons, checkboxes, and so on. By such a procedure, anomalies can be detected on a per object basis in the entire application screen included in the image data 32.

Description of Effects of Embodiment

In this embodiment, a screen test can be performed without pre-defining positions and so on of individual objects, so that efficiency of the screen test improves.

In this embodiment, before screens of a plurality of terminals 40 are tested, a normal model is pre-created for each object of a web screen. In the normal model, a rule is set that represents a feature of the object, such as a round shape in the case of a radio button. When a screen test is performed, the web screen to be tested is broken down into objects, and the objects are compared with pre-registered normal models.

As a result of comparison, the test result is processed as normal for an object with a small deviation from the normal model, and the test result is processed as anomalous for an object with a large deviation from the normal model. In this way, performing evaluation by creating the normal model for each object allows automation of tests on various types of terminals 40, OSes, and applications, regardless of the screen resolution, screen size, and OS of each terminal 40 and the type of the web browser on which tests are performed.

By providing the function that allows feedback on the model of an object that is processed as anomalous in spite of being normal, accuracy of the normal model can be increased and a test can be performed with higher accuracy.

Other Configurations

In this embodiment, the functions of the definition acquisition unit 21, the image acquisition unit 22, the source acquisition unit 23, and the anomaly detection unit 24 are realized by software. As a variation, however, the functions of the definition acquisition unit 21, the image acquisition unit 22, the source acquisition unit 23, and the anomaly detection unit 24 may be realized by a combination of software and hardware. That is, one or more of the functions of the definition acquisition unit 21, the image acquisition unit 22, the source acquisition unit 23, and the anomaly detection unit 24 may be realized by dedicated hardware and the rest may be realized by software.

The dedicated hardware is, for example, a single circuit, a composite circuit, a programmed processor, a parallel-programmed processor, a logic IC, a GA, an FPGA, or an ASIC. “IC” is an abbreviation for Integrated Circuit. “GA” is an abbreviation for Gate Array. “FPGA” is an abbreviation for Field-Programmable Gate Array. “ASIC” is an abbreviation for Application Specific Integrated Circuit.

Each of the processor 11 and the dedicated hardware is processing circuitry.

That is, regardless of whether the functions of the definition acquisition unit 21, the image acquisition unit 22, the source acquisition unit 23, and the anomaly detection unit 24 are realized by software or a combination of software and hardware, the functions of the definition acquisition unit 21, the image acquisition unit 22, the source acquisition unit 23, and the anomaly detection unit 24 are realized by the processing circuitry.

### REFERENCE SIGNS LIST

10: screen test apparatus, 11: processor, 12: memory, 13: input device, 14: display, 15: communication device, 21: definition acquisition unit, 22: image acquisition unit, 23: source acquisition unit, 24: anomaly detection unit, 31: definition data, 32: image data, 33: source file, 40: terminal, 50: request screen, 51: table, 52: checkbox, 53: text form, 54: characters, 61: HTML file, 62: CSS file

1. A screen test apparatus comprising:
processing circuitry to:
acquire, from a memory, definition data that defines, for each type of object to be displayed on a screen of an application, a rule for determining that an object is displayed; properly,
acquire, from the memory, image data that records a screen of the application during execution of the application, and
extract at least one type of object from the acquired image data by extracting an element that marks presence of the at least one type of object by image recognition and then cutting out an area in a vicinity of the element from the image data, and refer to the acquired definition data to determine whether a rule corresponding to a type of an extracted object is followed, so as to detect an anomaly in the screen of the application recorded in the image data.

2. The screen test apparatus according to claim 1,
wherein the processing circuitry acquires, as the image data, data that records a screen of the application of each terminal when the application is executed on terminals that differ in at least one of screen size and screen resolution, and
detects an anomaly in the screen of the application of each terminal recorded in the image data.

3. The screen test apparatus according to claim 1,
wherein the processing circuitry acquires, as the image data, data that records a screen of each type of the application during execution of different types of the application, and
detects an anomaly in the screen of each type of the application recorded in the image data.

4. The screen test apparatus according to claim 1,
wherein the processing circuitry refers to element data that defines, for each type of object to be displayed on the screen of the application, at least one of elements which are a character and a graphic displayed adjacent to or in a vicinity of an object, and extracts the at least one type of object from a side of or inside an extracted element in the image data.

5. The screen test apparatus according to claim 1,
wherein the processing circuitry acquires, as the definition data, data that defines a corresponding rule and also defines a model to be a basis for determining that the corresponding rule is followed or a recognition method for determining that the corresponding rule is followed for at least one type of object, and
when a model or a recognition method corresponding to the type of the extracted object is defined in the definition data, determines whether a rule corresponding to the type of the extracted object is followed using the model concerned or the recognition method concerned.

6. The screen test apparatus according claim 1,
wherein the processing circuitry acquires, as the definition data, data that defines a corresponding rule and records a template image of a modeled object for at least one type of object, and
wherein when a template image corresponding to the type of the extracted object is recorded in the definition data, unit processing circuitry determines whether a rule corresponding to the type of the extracted object is followed by performing template matching using the template image concerned.

7. The screen test apparatus according to claim 1,
wherein when processing circuitry has determined that the rule corresponding to the type of the extracted object is not followed, the processing circuitry outputs a determination result, and accepts from a user an input of a judgment result as to whether the determination result that has been output is correct.

8. The screen test apparatus according to claim 7,
wherein when a judgment result indicating that the determination result that has been output is incorrect is input from the user, the processing circuitry accepts a modification of a rule defined in the definition data from the user, and causes the modification to be reflected in the definition data.

9. A non-transitory computer readable medium storing a screen test program that causes a computer to execute:
a definition acquisition process to acquire, from a memory, definition data that defines, for each type of object to be displayed on a screen of an application, a rule for determining that an object is displayed properly;
an image acquisition process to acquire, from the memory, image data that records a screen of the application during execution of the application; and
an anomaly detection process to extract at least one type of object from the image data acquired by the image acquisition process by extracting an element that marks presence of the at least one type of object by image recognition and then cutting out an area in a vicinity of the element from the image data, and refer to the definition data acquired by the definition acquisition process to determine whether a rule corresponding to a type of an extracted object is followed, so as to detect an anomaly in the screen of the application recorded in the image data.
